(19) United States
(12) Patent Application Publication
(10) Pub. No.: US 2013/0324120 A1
(43) Pub. Date: Dec. 5, 2013

(54) LOCAL OPERATIONAL DATA UPLOAD

(71) Applicants: Federico Boccardi, Cernusco Sul Naviglio (IT); Howard C. Huang, New York, NY (US); Reinaldo A. Valenzuela, Holmdel, NJ (US)

(72) Inventors: Federico Boccardi, Cernusco Sul Naviglio (IT); Howard C. Huang, New York, NY (US); Reinaldo A. Valenzuela, Holmdel, NJ (US)

(21) Appl. No.: 13/485,319

(22) Filed: May 31, 2012

(51) Int. Cl. H04W 8/00

(52) U.S. Cl. 455/435.1

(57) ABSTRACT

A mobile device of an apparatus in one example is configured to register with a communication network over a wireless interface through employment of a plurality of parameters for the wireless interface. The mobile device is configured to record operational data in real-time. The mobile device is configured to upload the operational data to a network element of the communication network for optimization of the communication network and/or one or more of the plurality of parameters.

### BACKGROUND

Wireless communication networks employ parameters that control various resources and operations of the network, such as physical-layer operation and resource allocation. The parameters may comprise threshold levels, timer durations, power settings, periodicity settings, and others known in the art. Some parameters for the operation of the wireless communication network must be frequently updated to optimize system performance and to address dynamic usage patterns.

Network optimization is improved by obtaining information from mobile devices communicating with the network, such as channel measurements and operational statistics. This information can be obtained from drive tests sponsored by the network operator. Alternatively, real-time data can be obtained from the mobile device on control channels (for example, channel quality indicator bits). Real-time information is especially useful for self-organizing network (SON) techniques which automatically configure and optimize the operation of cellular networks with minimal interaction from the network operator. SON techniques have been proposed for optimizing coverage, load balancing, handoff, and fractional frequency reuse.

However, non-real-time data obtained through drive tests is often expensive and time-consuming. Drive tests are typically performed when a network is deployed for the first time and thus do not provide long-term characteristics of the network. On the other hand, real-time data obtained from mobile devices through control channels is limited in quantity due to bandwidth of the control channel and is typically available only when the mobile device is actively transmitting data.

### SUMMARY

The invention in one implementation encompasses an apparatus. The apparatus comprises a mobile device configured to register with a communication network over a wireless interface through employment of a plurality of parameters for the wireless interface. The mobile device is configured to record operational data in real-time. The mobile device is configured to upload the operational data to a network element of the communication network for optimization of the communication network and/or one or more of the plurality of parameters.

Another implementation of the invention encompasses an apparatus. The apparatus comprises a communication network with a wireless interface. The communication network is configured to register a mobile device over the wireless interface through employment of a plurality of parameters for the wireless interface. The communication network is configured to receive, from the mobile device, operational data recorded in real-time by the mobile device. The communication network is configured to perform a network management procedure through employment of the operational data received from the mobile device for optimization of the communication network and/or one or more of the plurality of parameters.

Yet another implementation of the invention encompasses a method. A mobile device is registered with a communication network over a wireless interface through employment of a plurality of parameters for the wireless interface. Operational data is recorded on the mobile device in real-time. The operational data is uploaded to a network element of the communication network for optimization of the communication network and/or one or more of the plurality of parameters.

### DESCRIPTION OF THE DRAWINGS

Features of example implementations of the invention will become apparent from the description, the claims, and the accompanying drawings in which:

FIG. 1 is a representation of one implementation of an apparatus that comprises a communication network and a mobile device.

FIG. 2 is a representation of one process flow for uploading local operational data from the mobile device to the communication network of FIG. 1.

### DETAILED DESCRIPTION

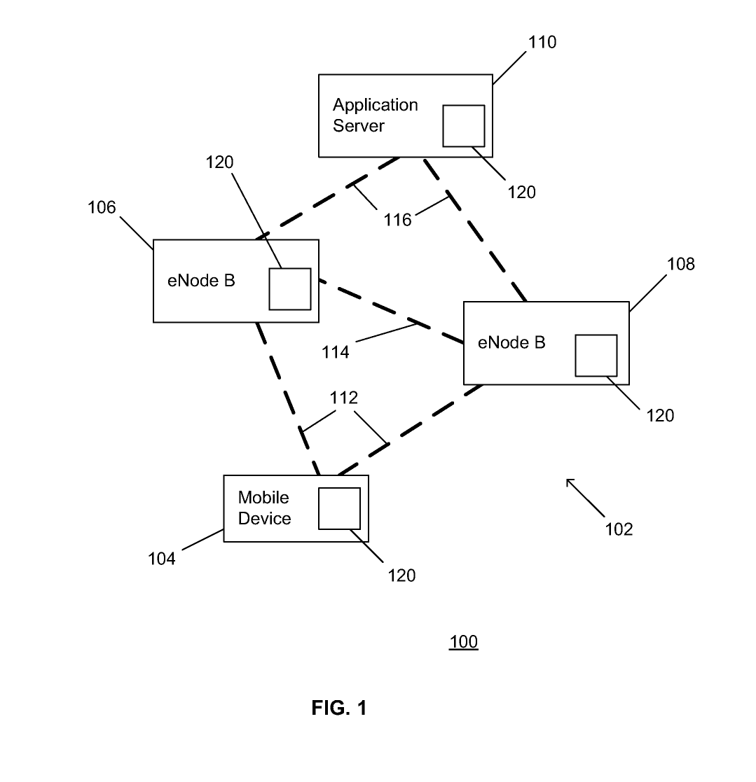

Turning to FIG. 1, an apparatus 100 in one example comprises a communication network 102 and a mobile device 104. The communication network 102 in one example comprises a wireless communication network operated by a service provider, such as a cellular or mobile data network, 3G or 4G network (3rd Generation Partnership Project), Wi-Fi network, Wi-Max network, Institute of Electrical and Electronics Engineers' (IEEE) 802.11 standard compatible network, or other networks as will be understood by those skilled in the art.

The communication network 102 in one example comprises a plurality of network elements, such as network elements 106, 108, and 110, which cooperate to provide a wireless data and/or wireless voice service. The network elements 106 and 108 in one example comprise base stations or wireless access points configured to provide a wireless interface 112 or “air interface” for the communication network 102 to the mobile device 104. The network elements 106 and 108 comprise an interface 114 for communication with each other. In the example shown in FIG. 1, the communication network 102 comprises a 4G or 3GPP Long Term Evolution (LTE) network with enhanced Node Bs (eNodeBs) 106 and 108. Where the network elements 106 and 108 comprise eNodeBs, the wireless interface 112 is the Uu interface and the interface 114 is the X2 interface, as will be appreciated by those skilled in the art.

The network element 110 in one example comprises an application server 110. The network elements 106 and 108 in one example communicate with the network element 110 over an interface 116. Where the network elements 106 and 108 comprise eNodeBs, the interface 116 is the S1 interface, as will be appreciated by those skilled in the art.

The communication network 102 in one example is configured to perform one or more network management procedures, such as self-organizing network (SON) techniques. The network management procedures in one example are employed by the service provider to reconfigure the communication network 102, for example, to optimize coverage, load balancing, handovers, and fractional frequency re-use for the communication network 102. Additional network management procedures will be apparent to those skilled in the art.

The network management procedures in one example are manually executed by the service provider. In another example, the network management procedures are automatically executed on a predetermined schedule, upon a predetermined event, or other criteria. The network management procedures may be performed by one or more of the network elements 106, 108, and/or 110. In one example, the network element 106 performs a network management procedure and sends a corresponding update to the network element 108 over the interface 114. In another example, the application server 110 performs the procedure and broadcasts the update to the eNodeBs 106 and 108.

The mobile device 104 in one example comprises a mobile phone, smart phone, personal digital assistant, or other electronic device capable of wireless communication. The mobile device 104 is configured to register with the communication network 102, for example, to use a communication channel of the wireless interface 112. The mobile device 104 in one example employs a plurality of parameters for the wireless interface 112. The mobile device 104 in one example selects or optimizes one or more of these parameters based on the channel measurements or other operational data. The plurality of parameters may comprise global parameters and/or local parameters. Global parameters are those parameters usable by multiple mobile devices, for example, system-wide parameters or cell-specific parameters. Local parameters are those used by a specific mobile device.

During operation, the mobile device 104 in one example is configured to take one or more of channel measurements, feedback measurements, and/or perform channel estimation for the wireless interface 112. Additional measurements will be apparent to those skilled in the art. The mobile device 104 may also receive information related to the wireless interface 112 from the network 104. One or more of the measurements, estimates, parameters, and/or related information form operational data that is local to the mobile device 104 and may be stored in an activity log, data file, database, or other data storage means. The operational data may also comprise information from the mobile device 104. The local operational data in one example is similar to or may comprise data that would overlap with data collected on drive tests, but it is used by the mobile device 104. In a further example, the local operational data comprises information that is not obtained through a drive test or other network diagnostic test. For example, the local operational data may include quality of service (QoS) metrics such as packet error rates or other performance data. The local operational data, or a portion thereof, may be specific or unique to a certain mobile device, as opposed to other instances of the mobile device 104 that may register with the communication network 104. For example, the parameters on one mobile device 104 may be different from those on another mobile device served by the same network or the same base station.

One or more of the mobile device 104 and/or the network elements 106, 108, and 110 in one example comprise an instance of a recordable data storage medium 120, as described herein. The mobile device 104 in one example is configured via firmware or software stored in the recordable data storage medium 120, such as a downloadable application (“app”). The application may be downloaded and installed by a user (not shown) of the mobile device 104 or by the service provider.

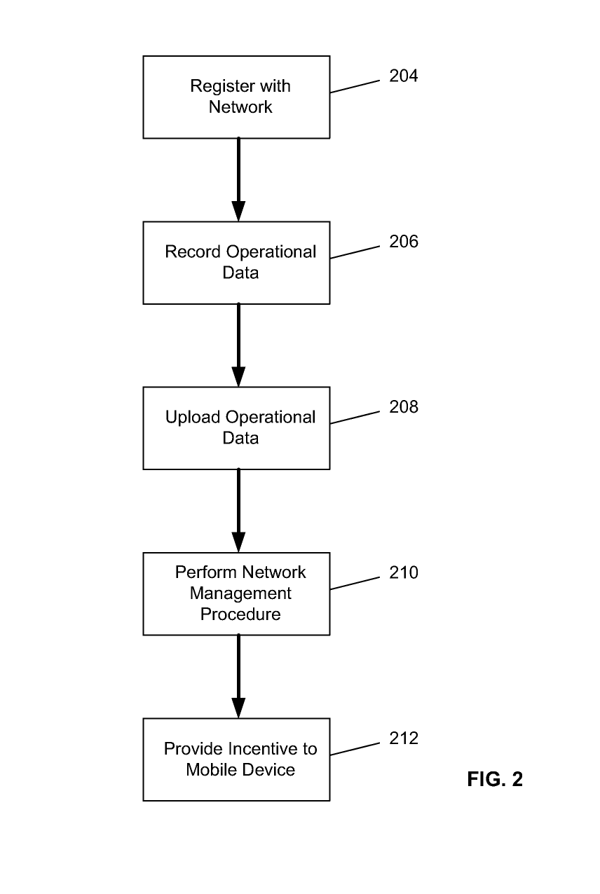

An illustrative description of operation of the apparatus 100 is presented, for explanatory purposes. Turning to FIG. 2, a process flow 200 in one example is performed by the apparatus 100. The mobile device 104 registers (STEP 204) with the communication network 102, as will be understood by those skilled in the art. For example, the mobile device 104 cooperates with one or more of the network elements 106, 108, and 110 or other network elements such as a home subscriber server (not shown) of the communication network 104 for selection of a network element 106 or 108 that will initially provide the wireless interface 112 to the mobile device 104.

During registration, the mobile device 104 in one example initializes or determines values for one or more of the parameters for the wireless interface 112. After registration, the mobile device 104 and the communication network 102 cooperate to maintain the registration. For example, the mobile device 104 may monitor and/or adjust the parameters for the wireless interface 112 or may be handed off to another network element, as will be appreciated by those skilled in the art.

The mobile device 104 in one example records (STEP 206) the local operational data associated with the wireless interface 112. The local operational data in one example comprises one or more of: the parameters for the wireless interface 112, channel information and/or measurements, location or timestamp data, and other data, as will be appreciated by those skilled in the art. Accordingly, as the mobile device 104 monitors and adjusts the parameters, new values may be recorded. The mobile device 104 in one example records the local operational data in real-time or near real-time. The size of the local operational data may be limited by a circular logging technique.

The mobile device 104 uploads (STEP 208) the local operational data to the communication network 102. For example, one or more of the network elements 106, 108, and/or 110 receive the local operational data. The upload may be performed over a data channel of the wireless interface 112, a separate messaging protocol such as text messaging, or over another data connection. For example, when connected to both the communication network 102 and another network (not shown), such as a Wi-Fi network or wired network via tethering, the mobile device 104 may upload over the other network. In another example, the mobile device 104 may upload or transfer the local operational data to an intermediate device such as a personal computer via a wireless or wired connection. The personal computer then completes the upload to the communication network 102. Where the mobile device 104 uses a data channel to the communication network 102, it may be configured to use only a portion of the available bandwidth. For example, a total channel bandwidth of the wireless interface 112 is shared between the local operational data and user data (e.g., user applications, Internet browsing, streaming music, etc.).

The mobile device 104 may perform the upload: 1) as the local operational data is recorded in STEP 206 (e.g., real-time or near real-time); 2) in one or more subsequent sessions at a later time; or 3) a first portion as the data is recorded and a remainder in one or more subsequent sessions. Advantageously, recording the operational data at a first time and uploading at a second time provides a delay or time shift that may allow for a higher volume of data to be uploaded or additional processing prior to the upload.

A time for uploading during later sessions may be pre-selected or dynamically determined by one or both of the user and the service provider. In a first example, the user of the mobile device 104 selects one or more times (e.g., 2:00 am). In a second example, the user and/or the service provider employ one or more criteria for dynamically determining the times for the upload. Examples of criteria include available power to the mobile device 104 (e.g., high or low battery levels, running on external power, etc.), signal strength or reception to the communication network 102, current usage of the mobile device 104 by the user, availability of another data connection, current load on the communication network 102. Criteria may be selected to reduce an impact of the upload on the user's experience or on the communication network 102, as will be appreciated by those skilled in the art. The upload may also be paused, postponed, or canceled based on a change in the above-mentioned criteria.

One or more data processing steps are optionally performed on the local operational data before and/or after being uploaded. Data processing steps may include one or more of data compression, data mining, data extraction, statistical analysis, duplicate data removal, or other steps, as will be appreciated by those skilled in the art. The data processing steps may be performed by one or more of the mobile device 104 or the network elements 106, 108, and 110. In one example, the mobile device 104 extracts a portion of the local operational data, such as values that exceed a threshold, and compresses it prior to uploading. In another example, the mobile device 104 performs statistical analysis on the local operational data to obtain new data and also removes data that is older than a predetermined threshold (e.g., one week). The new data may be merged with all or a part of the local operational data prior to uploading. In yet another example, the mobile device 104 uploads the local operational data in its entirety for processing by the application server 110, as will be appreciated by those skilled in the art.

The communication network 102 in one example performs (STEP 210) the one or more network management procedures using the local operational data. Advantageously, the network management procedures may be more effective using the local operational data due to increased accuracy and additional information. For example, a GPS-based location of the mobile device 104 may be included with channel measurements to supplement location data obtained at the eNodeBs. Additional network management procedures may be enabled by the use of local operational data, as will be appreciated by those skilled in the art.

As described above, the network management procedures may be manually or automatically executed. For example, the procedures may run after an upload of the local operational data from the mobile device 104. In another example, the communication network 102 may receive a plurality of uploads from a plurality of instances of the mobile device 104 before running the procedures. Where a plurality of uploads are received, the communication network 102 in one example performs additional processing on the uploads, as will be appreciated by those skilled in the art.

The mobile device 104 in one example cooperates with one or more of the network elements 106, 108, and 110 to perform codebook optimization based on the local operational data. In a first example, the mobile device 104 optimizes its codebook for the wireless interface 112 based on its own channel measurements and includes the codebook in the local operational data for upload to the communication network 102. In a second example, a plurality of mobile devices 104 uploads the channel measurements as part of the local operational data. The communication network 102 then optimizes the codebook based on local operational data from the plurality of mobile devices, as will be appreciated by those skilled in the art.

The service provider of the communication network 102 may optionally provide an incentive to the user of the mobile device 104 in exchange for the upload of the local operational data. The incentives may include additional services or features provided to the users, service discounts or other financial incentives, or other incentives. In one example, the user might receive additional calling minutes or data allowances for each upload. Where the above-mentioned functionality is provided via an application installed on the mobile device 104, the user may configure the application to select their desired incentive. Incentives may be provided as a flat-rate (e.g., 100 minutes per month) or in a selected ratio, such as receiving 100 MB of monthly data usage for each 10 MB of local operational data uploaded. Additional incentive arrangements will be apparent to those skilled in the art.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more computer-readable non-transitory media. The computer-readable non-transitory media may store software, firmware and/or assembly language for performing one or more portions of one or more implementations of the invention. Examples of a computer-readable non-transitory medium for the apparatus 100 comprise the recordable data storage media 120 of the mobile device 104 and the network elements 106, 108, and 110. The computer-readable non-transitory medium for the apparatus 100 in one example comprise one or more of a magnetic, electrical, optical, biological, and atomic data storage medium. For example, the computer-readable non-transitory media comprise floppy disks, magnetic tapes, CD-ROMs, DVD-ROMs, hard disk drives, and/or electronic memory.

The steps or operations described herein are just for example. There may be many variations to these steps or operations without departing from the spirit of the invention. For instance, the steps may be performed in a differing order, or steps may be added, deleted, or modified. Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a mobile device configured to register with a communication network over a wireless interface through employment of a plurality of parameters for the wireless interface;
wherein the mobile device is configured to record operational data in real-time;
wherein the mobile device is configured to upload the operational data to a network element of the communication network for optimization of the communication network and/or one or more of the plurality of parameters.

2. The apparatus of claim 1, wherein the plurality of parameters comprise global parameters for the communication network and/or local parameters for the mobile device.

3. The apparatus of claim 1, wherein the operational data comprises one or more of: a channel estimate, a channel measurement, a quality of service metric, a local parameter for the mobile device, or an optimized codebook for the wireless interface.

4. The apparatus of claim 1, wherein the mobile device is configured to process the operational data before uploading the operational data.

5. The apparatus of claim 4, wherein the mobile device is configured to perform one or more of data compression, data mining, data extraction, statistical analysis, and/or duplicate data removal on the operational data before uploading.

6. The apparatus of claim 1, wherein the mobile device is configured to record the operational data at a first time and to upload the operational data at a second time;
wherein the second time is preselected by a user of the mobile device.

7. The apparatus of claim 1, wherein the mobile device is configured to record the operational data at a first time and to upload the operational data at a second time;
wherein the second time is dynamically determined based on available power to the mobile device, signal strength over the wireless interface, current usage of the mobile device, availability of another data connection, and/or a current load on the communication network.

8. The apparatus of claim 1, wherein the mobile device is configured by a downloadable application to perform the upload of the operational data to the network element.

9. The apparatus of claim 1, wherein the mobile device is configured to allow a user of the mobile device to select a service or financial incentive in exchange for the upload of the operational data.

10. An apparatus, comprising:
a communication network that comprises a wireless interface;
wherein the communication network is configured to register a mobile device over the wireless interface through employment of a plurality of parameters for the wireless interface;
wherein the communication network is configured to receive, from the mobile device, operational data recorded in real-time by the mobile device;
wherein the communication network is configured to perform a network management procedure through employment of the operational data received from the mobile device for optimization of the communication network and/or one or more of the plurality of parameters.

11. The apparatus of claim 10, wherein the operational data comprises one or more of: a channel estimate, a channel measurement, a quality of service metric, a local parameter for the mobile device, or an optimized codebook for the wireless interface.

12. The apparatus of claim 10, wherein the communication network is configured to perform one or more of data mining, data extraction, and/or statistical analysis on the operational data before performing the network management procedure.

13. The apparatus of claim 10, wherein the network management procedure comprises a self-organizing network technique.

14. The apparatus of claim 10, wherein the network management procedure reconfigures the wireless interface for one or more of coverage optimization, load balancing, handovers, and/or fractional frequency re-use.

15. The apparatus of claim 10, wherein the communication network is configured to register a plurality of mobile devices that comprise the mobile device;
wherein the communication network is configured to receive operational data from the plurality of mobile devices;
wherein the communication network is configured to perform the network management procedure through employment of the operational data from the plurality of mobile devices.

16. The apparatus of claim 10, wherein the communication network is configured to provide a service or financial incentive to a user of the mobile device in exchange for the receipt of the operational data.

17. A method, comprising the steps of:
registering a mobile device with a communication network over a wireless interface through employment of a plurality of parameters for the wireless interface;
recording operational data on the mobile device in real-time;
uploading the operational data to a network element of the communication network for optimization of the communication network and/or one or more of the plurality of parameters.

18. The method of claim 17, wherein the step of uploading comprises:
performing one or more of data compression, data mining, data extraction, statistical analysis, and/or duplicate data removal on the operational data before uploading.

19. The method of claim 17, wherein the step of recording comprises:
recording the operational data at a first time;
wherein the step of uploading comprises:
uploading the operational data at a second time, wherein the second time is preselected by a user of the mobile device.

20. The method of claim 17, wherein the step of recording comprises:
recording the operational data at a first time;
wherein the step of uploading comprises:
uploading the operational data at a second time, wherein the second time is dynamically determined based on available power to the mobile device, signal strength over the wireless interface, current usage of the mobile device, availability of another data connection, and/or a current load on the communication network.
